(19) United States
(12) Patent Application Publication
(10) Pub. No.: US 2013/0321126 A1
(43) Pub. Date: Dec. 5, 2013

(54) WIRELESS DEVICE, INFORMATION PROVIDING APPARATUS AND WIRELESS COMMUNICATION METHOD

(71) Applicant: KABUSHIKI KAISHA TOSHIBA, Tokyo (JP)

(72) Inventors: Koji AKITA, Yokohama-shi (JP); Ryoko MATSUO, Tokyo (JP); Seiichiro HORIKAWA, Yokohama-shi (JP); Takayoshi ITO, Yokohama-shi (JP); Kengo IWASAKI, Yokohama-shi (JP)

(21) Appl. No.: 13/908,450

(22) Filed: Jun. 3, 2013

(30) Foreign Application Priority Data
Jun. 4, 2012 (JP) 2012-127377

(51) Int. Cl. G07C 9/00

(52) U.S. Cl. CPC G07C 9/00007
USPC 340/5.61

(57) ABSTRACT

A wireless device has a first information acquisition part to acquire first information when a first gate is passed through, a second information generator to generate second information by using the first information, a third information acquisition part to acquire third information by a wireless communication using the second information and invalidate the third information after a predetermined time period is elapsed since the third information is acquired, and a service executing part to execute a service by using the third information. An area capable of acquiring the third information by the third information acquisition part is broader than an area capable of acquiring the first information by the first information acquisition part.

### CROSS REFERENCE TO RELATED APPLICATIONS

This application is based upon and claims the benefit of priority from the prior Japanese Patent Application No. 2012-127377, filed on Jun. 4, 2012, the entire contents of which are incorporated herein by reference.

### FIELD

An embodiment of the present invention relates to a wireless device, an information providing apparatus and a wireless communication method.

### BACKGROUND

There is a known technique in which access to contents in the wireless device is permitted only when it is possible to receive a signal transmitted from a specific wireless device. By using this technique, it is possible to restrict an area for accessing the contents.

This technique gives an access authority of the contents in an area capable of receiving a radio wave from the specific wireless device. However, the radio wave is generally attenuated in accordance with distance. Since the attenuated amount changes by various influences due to a surrounding environment, it is impossible to accurately identify the area that the radio wave reaches. Therefore, the access to the contents may be permitted to an unintended wireless device, and thus the contents may be illegally used.

### BRIEF DESCRIPTION OF THE DRAWINGS

FIG. 1 is a block diagram showing a schematic configuration of a wireless device 1 according to a first embodiment.

FIG. 2 is a diagram showing a situation that a user passes through the first gate 21.

FIG. 3 is a diagram showing a situation that a wireless device acquires the third information from an information providing apparatus.

FIG. 4 is a diagram showing a location of the first gate 21 and an acquisition range of data.

FIG. 5 is a block diagram showing schematic configuration of the wireless device 1 in which a data holding part 6 is added.

FIG. 6 is a diagram showing a situation that a user passes through the second gate 24.

FIG. 7 is a diagram showing locations of the first and second gates 21 and 24 and an area capable of acquiring third information.

FIG. 8 is a block diagram showing schematic configuration of the information providing apparatus 10 according to the fourth embodiment.

FIG. 9 is a sequence diagram showing one example of a processing procedure when the authentication is performed using the second information.

FIG. 10 is a sequence diagram when the first information is transmitted from the wireless device 1 to the second information generator 12.

FIG. 11 is a sequence diagram in the case where the second information is not the authentication key, but an encryption (decryption) key.

FIG. 12 is a block diagram showing schematic configuration of the wireless device 1 according to the fifth embodiment.

FIG. 13 is a block diagram showing schematic configuration of the information providing apparatus 10 according to the fifth embodiment.

### DETAILED DESCRIPTION

According to one embodiment, a wireless device has a first information acquisition part to acquire first information when a first gate is passed through, a second information generator to generate second information by using the first information, a third information acquisition part to acquire third information by a wireless communication using the second information and invalidate the third information after a predetermined time period is elapsed since the third information is acquired, and a service executing part to execute a service by using the third information. An area capable of acquiring the third information by the third information acquisition part is broader than an area capable of acquiring the first information by the first information acquisition part. Embodiments will now be explained with reference to the accompanying drawings.

### First Embodiment

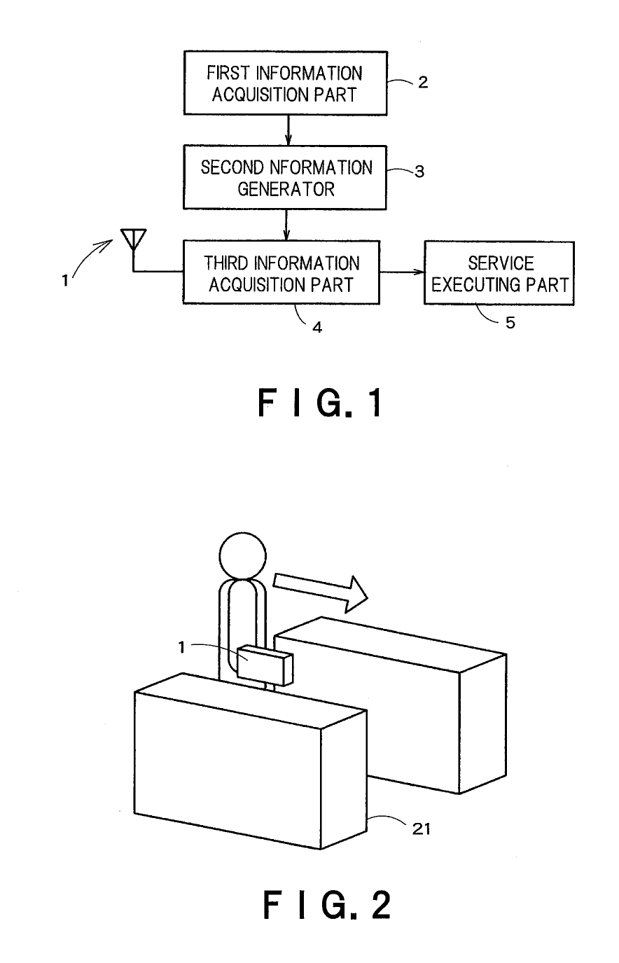

FIG. 1 is a block diagram showing a schematic configuration of a wireless device 1 according to a first embodiment. A wireless device 1 of FIG. 1 is a portable wireless device such as a cellar phone, a smart phone, a personal computer, etc.

The wireless device 1 of FIG. 1 has a first information acquisition part 2, a second information generator 3, a third information acquisition part 4 and a service executing part 5.

The first information acquisition part 2 acquires first information when the wireless device 1 passes through a first gate. The second information generator 3 generates second information by using the acquired first information.

The third information acquisition part 4 acquires third information from an information providing apparatus 10 by wireless communication by using the second information, and then invalidates the third information after a predetermined time period is elapsed since the third information is acquired. The service executing part 5 executes a service by using the third information.

The second information cannot be generated as long as the wireless device 1 does not pass through the first gate. Therefore, a locational limitation is imposed on the generation of the second information. Since the third information cannot be acquired as long as the wireless device 1 is holding the second information, the third information cannot be acquired as long as the wireless device 1 does not pass through the first gate. Therefore, a locational limitation is also imposed on the acquisition of the third information. Furthermore, since the service is not executed as long as the wireless device 1 is holding the third information, the service cannot be generated as long as the wireless device 1 does not pass through the first gate, thereby restricting an area capable of executing the service.

In the present embodiment, a range capable of acquiring the third information by the third information acquisition part 4 is broader than a range capable of acquiring the first information by the first information acquisition part. Therefore, the first information can be acquired only when the wireless device 1 passes through the first gate, and the third information can be acquired when the wireless device 1 passes through the first gate and locates within the internal area. A user can acquire the third information in a relatively broad area, once the wireless device 1 passes through the first gate and locates within the internal area, thereby enhancing convenience for user.

The third information acquisition part 4 invalidates the third information after a predetermined time period is elapsed since the third information is acquired. Therefore, even if the wireless device 1 holds the second information, it is possible to avoid continuing to hold the third information over a long time, and also to avoid that the wireless device 1 executes the service over the long time. Therefore, it is possible to impose temporal restriction for execution of the service.

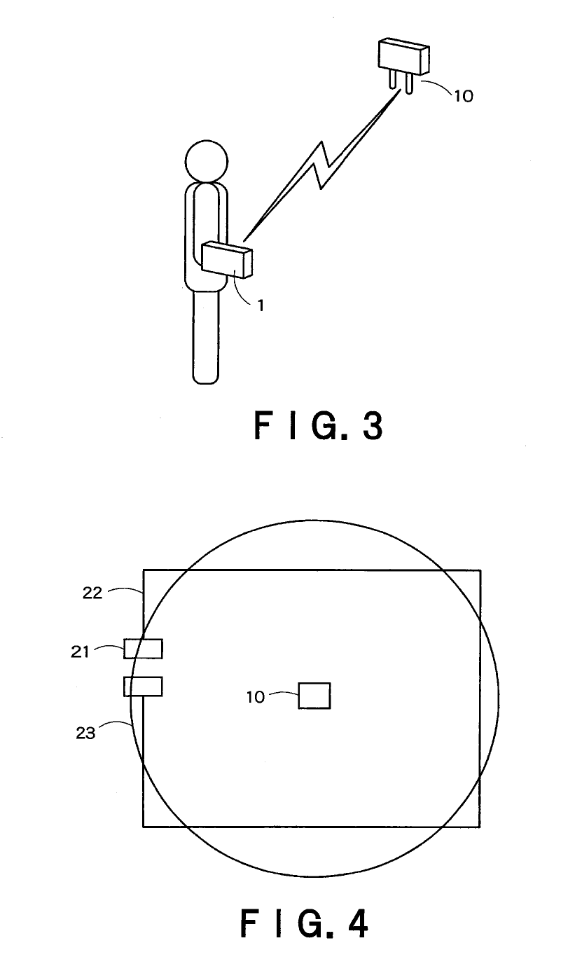

FIGS. 2 and 3 are diagrams showing examples of locations for disposing the wireless device 1, the first gate 21 and the information providing apparatus 10. FIG. 2 shows an example that a user holding the wireless device 1 of FIG. 1 passes through the first gate 21. FIG. 3 shows an example that the wireless device 1 passes through the first gate 21 to generate the second information by the wireless device 1 itself, and then acquires the third information from the information providing apparatus 10 by wireless communication.

As shown in FIG. 2, when a user holding the wireless device 1 passes through the first gate 21, the information acquisition part 2 acquires the first information. The first information is transmitted from, for example, the first gate 21. When a user passes through the first gate 21 and enters inside of the first gate 21, as shown in FIG. 3, the third information acquisition part 4 acquires the third information from the information providing apparatus 1 by wireless communication by using the second information generated from the first information.

The third information is transmitted by wireless communication from, for example, the information providing apparatus 10, as shown in FIG. 3. The second information is necessary to acquire the third information. Therefore, it is possible to restrict the acquisition of the third information by whether the wireless device 1 holds the second information. To be able to acquire the third information indicates that a user for holding the wireless device 1 passes through the first gate 21 and enters the internal area.

FIG. 4 is a diagram showing a location of the first gate 21 and an acquisition range of data. As shown in FIG. 4, the first gate 21 is provided in an entrance of the range 22 having a predetermined area. FIG. 4 shows an example that the range 22 has rectangle shape. However, shape and area of the range 22 are not limited.

The wireless device 1 acquires the first information at the first gate 21, and generates the second information by using the first information. The generated second information is used when the third information is acquired. That is, the second information is information necessary for acquiring the third information. Therefore, it is possible to impose a limitation to the acquisition of the third information by the second information generated using the first information. This means that acquisition of the third information is limited by whether the wireless device 1 passes through the first gate 21.

Furthermore, the second information can be generated by passing through the first gate 21. Therefore, to hold the second information indicates that the wireless device 1 locates in the range 22 of FIG. 4.

On the other hand, signal intensity of data provided by the information providing apparatus 1 by wireless communication attenuates in accordance with a distance from the transmitter. An area capable of acquiring data by the wireless device 1 is expressed as a circular area 23 of FIG. 4. Therefore, the area capable of acquiring data by the wireless device 1 is expressed as an overlapped area of the range 22 and the circuit area 23. This means that an area capable of acquiring the third information wirelessly transmitted by the information providing apparatus 10 can be restricted by using the first and second information.

The first information acquisition part 2 may acquire the first information by using, for example, proximity wireless communication. More specifically, a communication system using electromagnetic induction such as NFC (Near Field Communication) or Felica may be adopted, or a wireless communication system using extremely-high frequency may be adopted.

The first information acquisition part 2 may acquire the first information by using, for example, a digital camera. More specifically, a device for converting an image signal into coded data such as QR code (registered trademark) may be provided to acquire the first information.

A portion of the first information may be acquired at a location different from the first gate 21. For example, when a ticket is necessary to pass through the first gate 21, a portion of the first information may be acquired to buy the ticket.

The first information may be, for example, information regarding time or date passing through the first gate 21. The wireless device 1 generates the second information by using the first information. If the first information is information regarding time or date, it is possible to generate the second information regarding time or date. The third information acquisition part 4 acquires data by using the second information. If the second information is information regarding time or date, it is possible to change the type of data acquired by the third information acquisition part 4 in accordance with time or date. For example, when the second information generated in association with a certain date is used, the acquisition of data may be permitted on only that date.

Or the first information may be information regarding a location for disposing, for example, the first gate 21. When the first gate 21 is, for example, an entrance of a vehicle such as a train, a bus, a plain, a ship or the like, the first information may be information for identifying that entrance, for example, a name of that entrance. In this case, the second information becomes information regarding the entrance, and it is possible to change the type of the third information acquired by the third information acquisition part 4 in accordance with the entrance. For example, when both of a user entered from the entrance A and a user entered from the entrance B have reached the entrance C by the move of the vehicle, the type of data acquired after entered from the entrance C may be switched depending on from which of the entrances A and B the user is entered.

Or the first information may be information regarding a purpose passing through, for example, the first gate 21. When the first gate 21 is, for example, an entrance of a vehicle such as a train, a bus, a plain or a ship, the first information may be a destination moved getting on the vehicle. When the first gate 21 is, for example, an entrance of a movie theater, the first information may be a movie title to be watched. Or when the first gate is, for example, an entrance of a theme park, the first information may be the type of a ticket in the theme park. In this case, the wireless device 1 can generate the second information in association with the entered purpose, and change the type of the third information acquired by the third information acquisition part 4 in accordance with the entered purpose. For example, it is possible to switch data to be acquired for each movie title watched by a user in the movie theater.

The second information generator 3 may be, for example, a secure element. For example, the second information may be generated by an application in the secure element to store it into a memory in the secure element. The secure element is stored in, for example, an IC card or a SIM card. Even if there is a malicious access from outside, it is possible to safely protect the second information so that the second information is not read out without permission. By providing such a secure element, it is possible to assure a high security.

The generation of the second information by the second information generator 3 may not be performed, for example, soon after the first information is acquired. For example, the second information may be generated at timing of beginning a procedure for acquiring data by using the second information. For example, when a user holding the wireless device 1 inputs requirement of data acquisition, a procedure for acquiring data may be begun in accordance with this, and thus the second information may be generated.

An application (program) for generating the second information may be acquired with the first information by the first information acquisition part 2.

The service executed by the service executing part 5 may be, for example, access to data held by the wireless device 1.

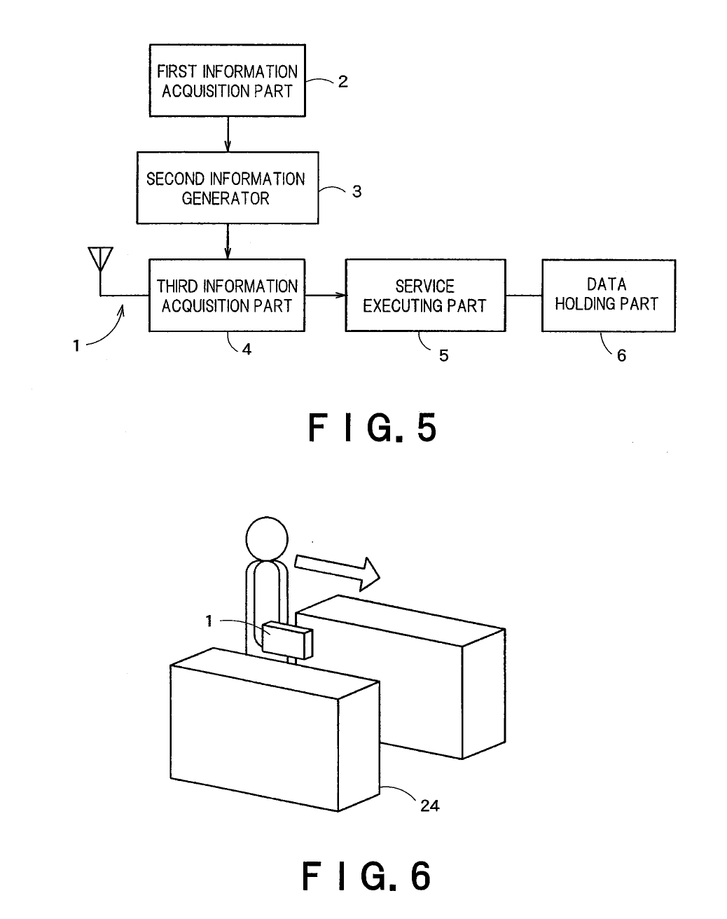

FIG. 5 is a block diagram showing schematic configuration of the wireless device 1 in which a data holding part 6 is added. The data holding part 6 of FIG. 5 holds accessible data by using the third information. That is, data held by the data holding part 6 cannot access without the third information. Therefore, it is possible to restrict access to data held in the data holding part 6, to a user satisfying a specific condition.

For example, among data acquired in advance, a partial special data such as premium content may be restricted so that a browse is permitted only in a specific facility. In this case, the third information can be acquired only in the specific facility, and it is possible to browse the premium content only when the third information is acquired. Therefore, it is possible to enhance attraction of the facility and increase the number of people entering the facility.

Furthermore, when the data holding part 6 shown in FIG. 5 is provided, a portion of data accessed by the service executing part 5 may be used for the generation of the second information. Here, a portion of data may be, for example, header information of data. Therefore, it is possible to generate the second information in accordance with data accessed by the service executing part 5, and thus to update the third information.

The service executed by the service executing part 5 may be access to the other equipment. The access to the other equipment may be, for example, to acquire data held to the other equipment by wireless communication. For example, when the other equipment for performing wireless distribution of contents exists in a range of wirelessly transmitting the third information, the access to the other equipment may be access to the contents wirelessly transmitted by the equipment. Or access to the other equipment may be, for example, the access to the other equipment and the execution of authentication process. The service based on the authentication may be performed. For example, the access to the other equipment and the execution of the authentication process are performed, and when the authentication is successful, a door controlled by the equipment may be unlocked.

The third information acquisition part 4 may be, for example, a wireless LAN, a Bluetooth (registered trademark), a cellular communication, a WiMAX (registered trademark). When the first information acquisition part 2 performs wireless communication, the first information acquisition part 2 and the third information acquisition part 4 may share at least a portion of a wireless communication system.

As described above, in the first embodiment, when a user holding the wireless device 1 passes through the first gate 21, the first information is acquired, and then when a user enters the internal region 22 from the first gate 21, the third information can be acquired from the information providing apparatus 10 using the second information generated by the wireless device 1 using the first information. Therefore, it is possible to impose restriction to the acquisition of the third information. Since the service cannot be executed without holding the third information, it is possible to impose restriction to the execution of the service. That is, as long as the first gate 21 is not passed through, the first information cannot be acquired, and as long as the first information is not acquired, the second information cannot be generated, and as long as there is not the second information, the third information cannot be acquired. In this way, as long as normal procedures are not taken, the service cannot be executed, thereby tightening a condition for executing the service.

### Second Embodiment

A second embodiment described below has a characteristic in which after a user passes through the first gate 21 and enters the internal region 22, restriction is imposed on acquisition of data depending on whether a user exits from a second gate.

In the second embodiment, a second gate for exit is provided in addition to the first gate 21 for entrance. A user holding the wireless device 1 passes through the first gate 21 to enter the internal region 22, and then passes through a second gate 24 to exit from the internal region 22, as shown in FIG. 6.

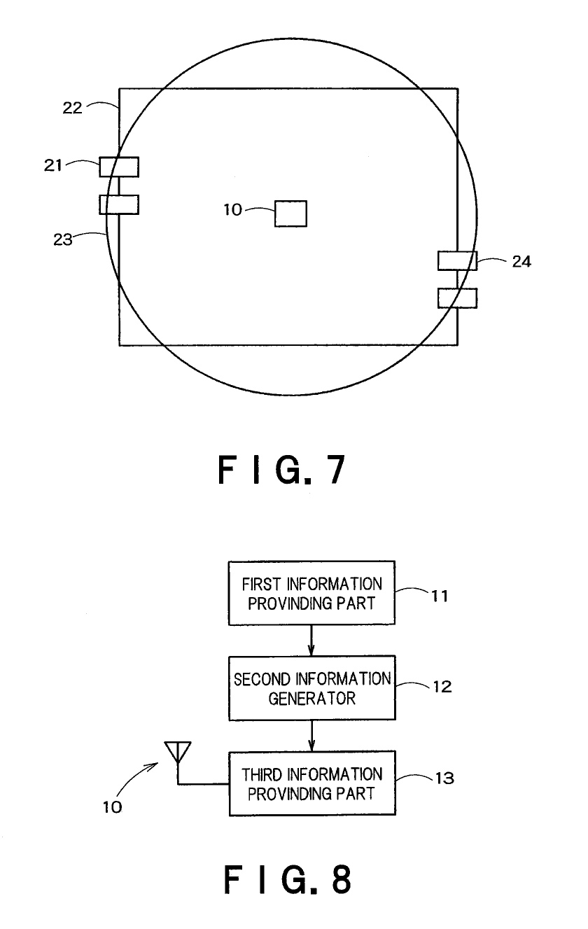

FIG. 7 is a diagram showing locations of the first and second gates 21 and 24 and an area capable of acquiring third information. In FIG. 6, the first gate 21 and the second gate 24 are provided in locations different from each other. The first gate 21 and the second gate 22 may be provided adjacently, or one gate may be used as the first gate 21 and the second gate 22.

The second information generator 3 according to the second embodiment invalidates the second information generated after passing through the first gate 21 when a user passes through the second gate 24.

In this way, when a user passes through the second gate 24, the second information is invalidated, and thus at a time when the wireless device 1 departs from the region 22 of FIG. 7, it is possible to inhibit the acquisition of the third information. Therefore, it is possible to avoid continuing to acquire the third information within the wireless communication area with the information providing apparatus, i.e. within the circuit area 23 of FIG. 7), even if a user departs from the region 22.

To invalidate the second information may be, for example, to delete the second information. In this case, since the second information disappears, in order to again validate the second information, the second information has to be again generated by using the first information. Furthermore, if not only the second information, but also the first information is deleted, as long as a user does not pass through the first gate 21 again, the first information cannot be acquired. The third information can be acquired only a period after passing through the first gate 21 until the wireless device 1 is exited from the second gate 24.

Or to invalidate the second information may be, for example, to inhibit access to the second information while holding the second information. In this case, since the second information is held in the wireless device 1, a process for validating again the access is simplified, thereby easily and quickly switching validation and invalidation of the second information.

When invalidating the second information, it may be determined whether to invalidate the second information, for example, based on the first information. For example, when the first information includes information regarding an expire period, and if an expire date is not elapsed at a time when the wireless device 1 passes through the second gate 24, the second information may be effective until the expire period ends, even if a use exits from the second gate 24.

Or when the second information is invalidated, it may be determined whether to be invalidated based on, for example, information capable of being acquired by the second gate 24. More specifically, when an act which passes through the second gate 24 and exits from the region 22 is temporary, and it is possible to know based on the information acquired by the second gate 24 that a user enters again in the region 22, it is unnecessary to invalidate the second information.

When the second information is invalidated, it is desirable to invalidate the third information previously acquired in order to inhibit the subsequent execution of the service.

As described above, according to the second embodiment, when a user passes through the second gate 24 and exits, the second information is invalidated. Therefore, it is impossible to acquire the third information after the exit, thereby inhibiting the continuous execution of the service.

### Third Embodiment

A third embodiment described hereinafter invalidates the second information after a predetermined time period is elapsed since the first information is acquired.

The second information generator 3 in the wireless device 1 according to the third embodiment generates the second information by using the first information, and then invalidates the second information after the predetermined time period is elapsed since the first information is acquired.

Therefore, even if the wireless device 1 continues to be present within the region 22 of FIG. 4 or FIG. 5, the second information is automatically invalidated after a predetermined time period is elapsed since the first information is acquired, thereby restricting a time period that the wireless device 1 can acquire the third information. Accordingly, it is possible to avoid a situation that the same wireless device 1 can acquire the third information over a long period, thereby restricting a period for executing the service.

As a concrete measure for determining whether a predetermined time period has been elapsed, for example, it is assumed that a timer measurement not shown is started at a time point when the first information acquisition part 2 acquires the first information and a signal is sent to the second information generator 3 to invalidate the second information at a time point when a time measured by the timer reaches a predetermined time.

In this way, the timer measurement is carried out in conjunction with the operations of the first information acquisition part 2 and the second information generator 3, thereby validating the second information for only an exact time period.

Or at a time point when the first information acquisition part 2 acquires the first information, a time adding a predetermined time to the time point may be calculated and managed, and if a time when the third information acquisition part 4 tries to acquire the third information exceeds the managed time, the second information may be invalidated. In this case, since the measurement by the timer becomes unnecessary, it is possible to simplify the process.

Even in the third embodiment, when the second information is invalidated, it is desirable to invalidate the previously acquired third information so that the service is not executed after that.

As described above, in the third embodiment, the second information is invalidated after a predetermined time period is elapsed since the first information is acquired. Therefore, even if the wireless device 1 passes through the first gate 21 and continues to be present within the internal region 22 for a long period, there is no likelihood that the wireless device 1 continues to acquire the third information over a long period, thereby restricting a period capable of executing the service.

### Fourth Embodiment

A fourth embodiment described below focuses on the information providing apparatus 10 for providing the wireless device 1 according to the first to third embodiments with third information.

FIG. 8 is a block diagram showing schematic configuration of the information providing apparatus 10 according to the fourth embodiment. The information providing apparatus 10 can transmit the third information to any wireless device 1 according to the first to third embodiments. More specifically, the information providing apparatus 10 may be configured by, for example, an entrance gate (first gate 21) disposed at an entrance of a vehicle such as a station, an airport or a harbor, and a wireless communication unit housed in the entrance gate. The entrance gate is disposed in a facility such as a movie theater, an amusement park, an art museum or a science museum.

The information providing apparatus of FIG. 8 has a first information providing part 11, a second information generator 12 and a third information providing apparatus. The first information providing part 11 provides the wireless device 1 passing through the first gate 21 with the first information. The second information generating part 12 generates the second information necessary for providing the third information by using the first information provided to the wireless device 1 by the first information providing part 11. The third information providing part 13 provides the third information by wireless communication using the second information, and stops providing the third information after a predetermined time period is elapsed since the first information is provided.

The second information generated by the second information generator 12 in the information providing apparatus 10 is the same as the second information generated by the second information generator 3 in the wireless device 1.

The third information providing part 13 does not provide a specific wireless device 1 with the third information, but provides the circular area 23 shown in FIGS. 4 and 6 with the third information by wireless communication. Since the third information is provided using the second information, only the wireless device 1 holding the same second information can acquire the third information. As a result, the information providing apparatus 10 can restrict an area for providing the third information.

When the third information providing part 13 provides the third information by using the second information, authentication for the wireless communication is performed using the second information, and the third information may be provided only when the authentication is successful. In this case, the second information functions as an authentication key.

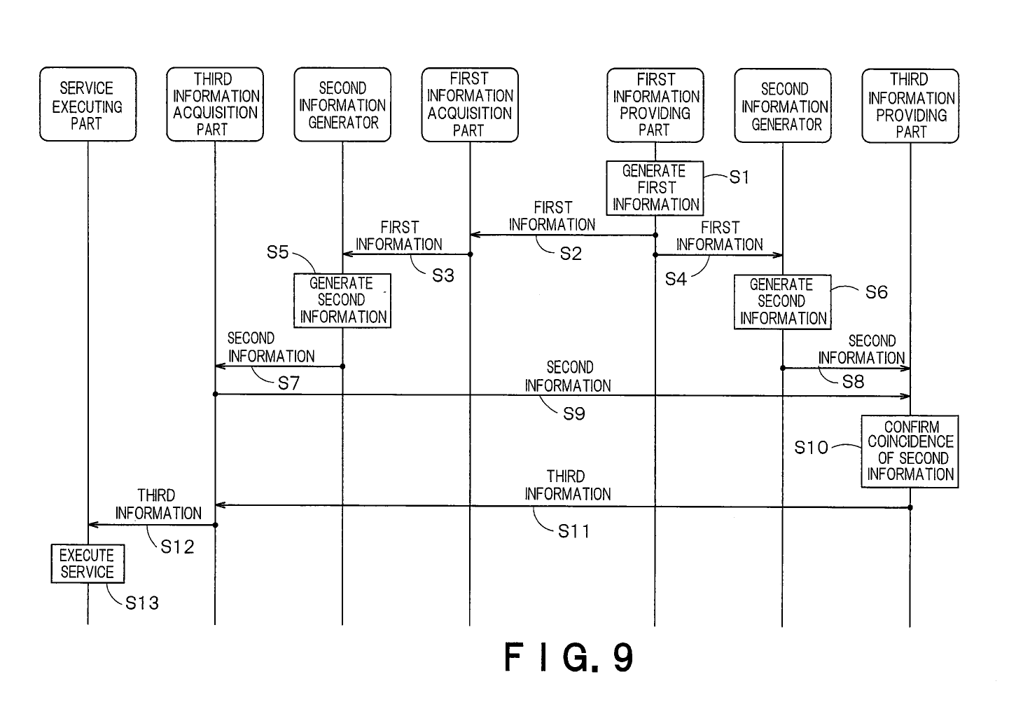

FIG. 9 is a sequence diagram showing one example of a processing procedure when the authentication is performed using the second information. When a user holding the wireless device 1 passes through the first gate 21, the first information providing part 11 generates the first information (step S1), and the generated first information is provided to the wireless device 1. The first information is acquired by the first information acquisition part 2 (step S2). The first information acquisition part 2 in the wireless device 1 transmits the acquired first information to the second information generator 3 (step S3). Before or after step S3, the first information providing part 11 in the information providing apparatus 10 transmits the first information provided to the wireless device 1, to the second information generator 12 (step S4).

The second information generator 3 in the wireless device 1 and the second information generator 12 in the information providing apparatus 10 generate the same second information by using the first information (steps S5 and S6).

The second information generator 3 in the wireless device transmits the generated second information to third information acquisition part 4 (step S7), and before or after step S7, the second information generator 12 in the information providing apparatus 10 transmits the generated second information to the third information providing part 13 (step S8).

Next, the third information acquisition part 4 in the wireless device 1 and the third information providing part 13 in the information providing apparatus 10 exchange the respective second information to perform the authentication (step S9). More specifically, it is confirmed whether the second information coincides with each other (step S10). When the coincidence is confirmed, it is determined that the authentication is successful, and the information providing apparatus 10 provides the third information in a predetermined wireless communication area (step S11). The third information acquisition part 4 in the wireless device 1, which holds the second information and locates in an area capable of performing wireless communication with the information providing apparatus 10, acquires the third information.

Next, the third information acquisition part 4 transmits the acquired third information to the service executing part 5 (step S12). The service executing part 5 executes the service by using the third information (step S13).

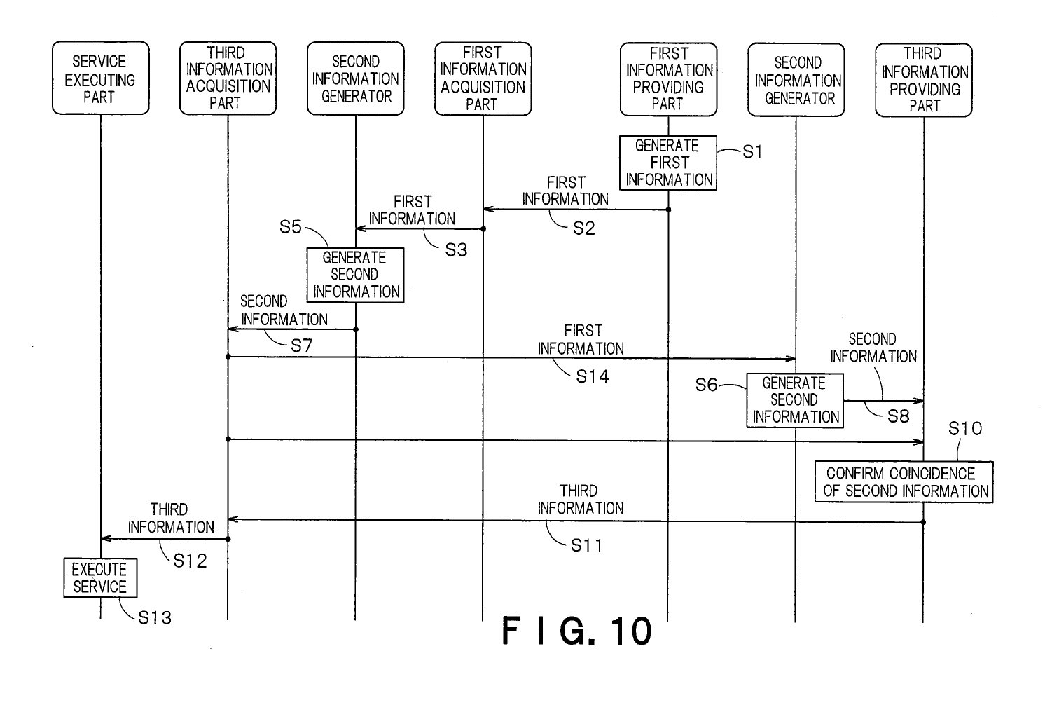

In FIG. 9, the second information generator 12 in the information providing apparatus 10 generates the second information by using the first information transmitted from the first information providing part 11. The first information may be transmitted to the second information generator 12 not from the first information providing part 11, but from the wireless device. The processing procedure in this case is shown in FIG. 10. In FIG. 10, the same step number is attached to each step common to FIG. 9, and differences will be mainly described hereinafter.

In FIG. 10, step S4 of FIG. 9 is omitted. Instead of that, after the second information is generated in the wireless device 1 (step S8), the first information is transmitted from the third information acquisition part 4 to the second information generator 12 in the information providing apparatus 10 (step

S14), and the second information generator 12 generates the second information by using the first information (step S6). The subsequent steps S6 to S13 are the same as the corresponding steps of FIG. 9.

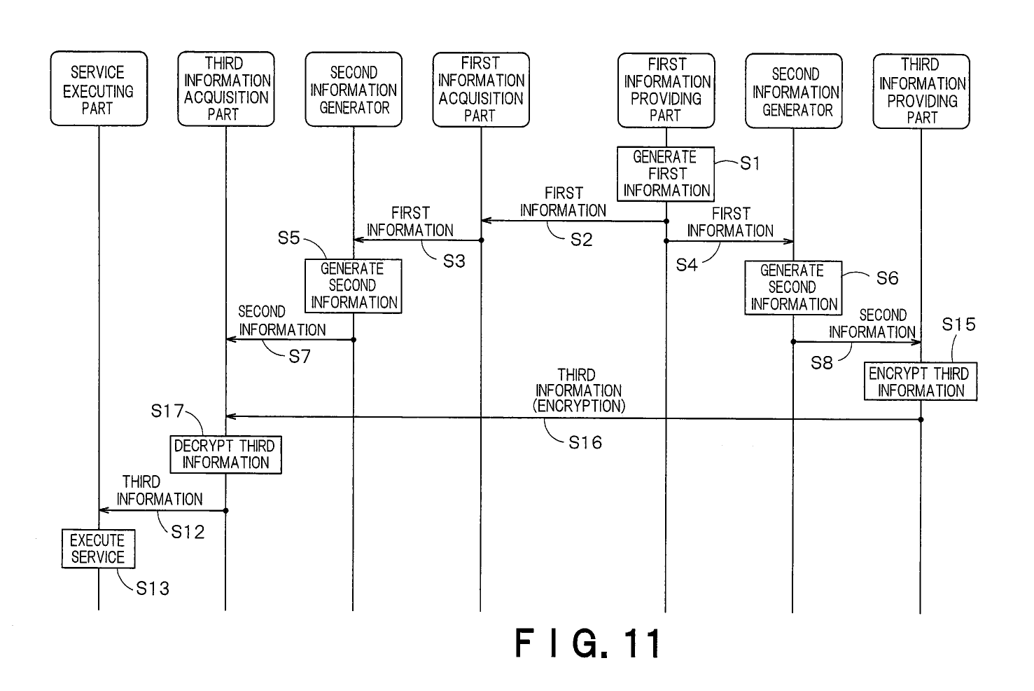

On the other hand, FIG. 11 is a sequence diagram in the case where the second information is not the authentication key, but an encryption (decryption) key. In FIG. 11, the same step number is attached to each step common to FIG. 9, and differences will be mainly described hereinafter. The steps S1 to S8 are the same as the corresponding steps of FIG. 9. Since the second information of FIG. 11 is the encryption (decryption) key, the third information providing part 13 encrypts the third information by using the second information generated by the second information generator 12 (step S15), and transmits the encrypted third information by wireless communication (step S16).

On the other hand, the wireless device 1 receives the encrypted third information, and decrypts it by using the second information generated by the second information generator 3 (step S17). After that, the third information acquisition part 4 transmits the decrypted third information to the service executing part 5 (step S12), and the service executing part 5 executes the service by using the third information (step S13).

Even in the case of using the second information in order to perform the authentication process as shown in FIGS. 9 and 10, or even in the case of using the second information in order to perform the encryption (decryption) process of the third information, the processing procedure that the wireless device 1 generates the second information is the same as the processing procedure that the second information generators 3 and 12 in the information providing apparatus 10 generates the second information, and thus the second information generated using the same first information become the same one.

The first information providing part 2 in the information providing apparatus 10 may be housed in the first gate 21. A wireless communication unit may be provided different from the first gate 21, and the third information providing part 13 may be provided in the wireless communication unit. The second information generator 12 may be housed in either of the first gate 21 or the wireless communication unit, or may be provided in an apparatus different from the first gate 21 and the wireless communication unit.

The second information generator 12 in the information providing apparatus 10 of FIG. 8 may invalidate the second information after a predetermined time period is elapsed since the first information providing unit 11 provides the wireless device 1 with the first information. In this case, as shown in

FIG. 9, even in the case where the second information generator 12 in the information providing apparatus 10 acquires the first information from the first information providing unit 11, or even in the case where the second information generator 12 acquires the first information from the wireless device 1, the second information may be invalidated after a predetermined time period is elapsed since the first information providing part 11 provides the wireless device 1 with the first information.

As described above, according to the fourth embodiment, the second information generator 12 in the information providing apparatus 10 generates the second information by using the first information provided to the wireless device 1. Therefore, the second information having the same content as that of the second information generated by the wireless device 1 can be generated. Accordingly, it is possible to perform the authentication process by using the second information generated by each of the wireless device 1 and the information providing apparatus 10 as the authentication key, or to perform the encryption (decryption) process of the third information by using the second information as the encryption (decryption) key, thereby improving security at a time of providing and acquiring the third information.

### Fifth Embodiment

In the above first to fourth embodiments, the information providing apparatus 10 does not intend to provide a specific wireless device 1 with the third information, but transmits the third information by wireless in a predetermined wireless communication area shown in the circular area of FIGS. 4 and 7, and the wireless device 1 determines whether the third information can be acquired. Therefore, when a plurality of the wireless devices capable of generating the second information by using the first information exists, multiple wireless devices can acquire the same third information. On the other hand, in the fifth embodiment described hereinafter, the information providing apparatus 10 transmits the third information capable of being acquired by only a specific wireless device 1.

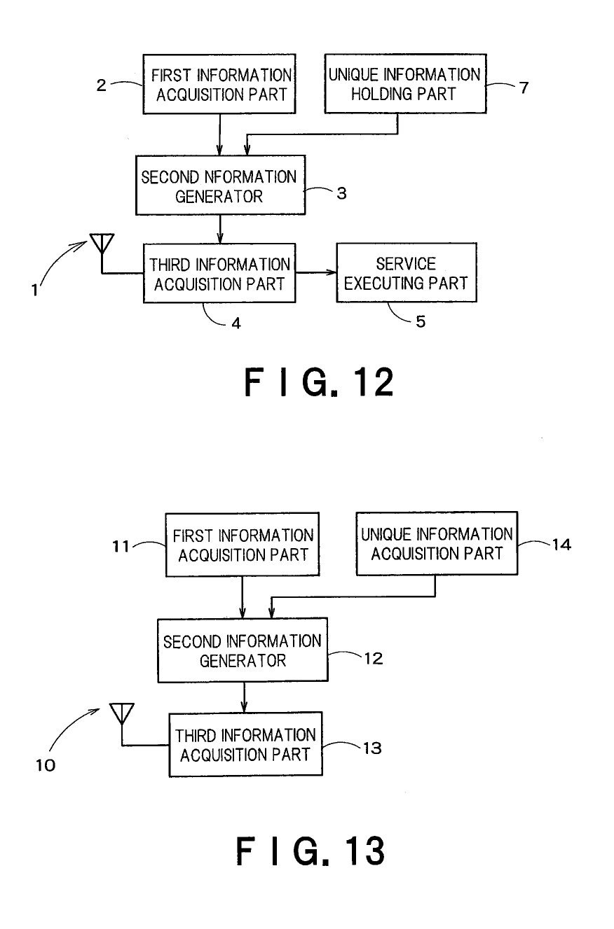

FIG. 12 is a block diagram showing schematic configuration of the wireless device 1 according to the fifth embodiment. In the wireless device 1 of FIG. 12, an unique information holding part 7 is added to the wireless device 1 of FIG. 1. The unique information holding part 7 holds an unique ID (hereinafter, unique information) unique to each wireless device 1. The second information generator 3 in the wireless device 1 of FIG. 12 generates the second information by using the unique information of the wireless device 1 in addition to the first information. Accordingly, the unique information of the wireless device 1 is included in the second information, and thus each wireless device 1 can be identified by the second information.

FIG. 13 is a block diagram showing schematic configuration of the information providing apparatus 10 according to the fifth embodiment. The information providing apparatus of FIG. 13 is configured by adding the unique information acquisition part 14 to the information providing apparatus of FIG. 8. The unique information acquisition part 14 acquires one unique information among the unique information of one or more the wireless device 1 registered in advance, or receives and acquires the unique information transmitted from the wireless device 1.

The second information generator 12 in the information providing apparatus 10 of FIG. 13 generates the second information by using the unique information acquired by the unique information acquisition part 14 in addition to the first information.

The third information providing part 13 in the information providing apparatus 10 transmits the third information by using the second information only when the second information transmitted from the wireless device 1 coincides with the second information generated by the second information generator 12 in the information providing apparatus 10. Since the third information is transmitted using the second information including the unique information of the wireless device 1, only the wireless device 1 having the same unique information can acquire the third information. Therefore, it is possible to limit the wireless device 1 capable of acquiring the third information to only one device, thereby avoiding illegal acquisition of the third information more strictly and improving security.

As measures that the unique information acquisition part 14 in the information providing apparatus 10 acquires the unique information of the wireless device 1, the following two measures are assumed. The first measure is to use a database in which the unique information of one or more wireless device 1 is registered. For example, when watching a movie in a bullet train, a user is required to register the unique information of the wireless device 1 in advance. In this case, the unique information acquisition part 14 accesses a database to select arbitrary unique information. The second information generator 12 generates the second information by using the selected unique information and the first information. The third information providing part 13 determines whether the generated second information coincides with the second information transmitted from the wireless device 1. These processes are repeated while changing the unique information registered in the database. When coinciding with the second information transmitted from the wireless device 1, the third information is transmitted using the second information at that time point. When the second information does not coincide in all the unique information registered in the database, the third information providing part 13 does not perform the transmission of the third information.

In the second measure, when the wireless device 1 passes through the first gate 21, the unique information of the wireless device 1 is transmitted to the information providing apparatus 10. The unique information acquisition part 14 in the information providing apparatus 10 receives and acquires the unique information transmitted from the wireless device 1. The second information generator 12 in the information providing apparatus 10 generates the second information by using the acquired unique information and the first information.

According to the second measure, the process of searching a specific unique information among the plurality of unique information becomes unnecessary. Therefore, the processing burden of the information providing apparatus 10 is reduced, but it is necessary to newly provide the wireless device 1 with a transmitter for transmitting the unique information to the information providing apparatus 10 when passing through the first gate 21.

FIG. 12 shows an example of adding the unique information holding part 7 to the wireless device 1. Similarly, the unique holding part 7 may be added to the wireless device 1 of FIG. 5.

As described above, according to the fifth embodiment, in addition to the first information, the second information is generated by using the unique information of the wireless device 1. The third information transmitted by the information providing apparatus 10 can be acquired by only a specific wireless device 1 having the same unique information. Even if a plurality of wireless devices 1 are present in the adjacent area, as long as the unique information does not coincide, the third information cannot be acquired. Therefore, it is possible to limit the wireless device 1 capable of acquiring the third information, thereby improving security.

At least a portion of functions performed by the above-mentioned wireless device 1 and information providing apparatus 10 may be constituted by at least one of hardware and software. When constituted by software, a program of executing at least a portion of the functions performed by the wireless device 1 and the information providing apparatus 10 is stored in a recording media such as a floppy disk or CD-ROM, and is loaded to a computer to execute its program. The recording media is not limited to a portable media such a magnetic disk or an optical disk, but a fixed recording media such as a hard disk drive or a memory may be used to store the program.

The program of executing at least a portion of the functions performed by the wireless device 1 and the information providing apparatus 10 may be distributed via a communication line such as Internet. The program may be distributed via a wired line or a wireless line such as Internet at a state of encrypting, modulating or compressing the program, or may be distributed at a state of being stored in the recording media.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wireless device, comprising:
a first information acquisition part configured to acquire first information when a first gate is passed through;
a second information generator configured to generate second information by using the first information;
a third information acquisition part configured to acquire third information by a wireless communication using the second information and invalidate the third information after a predetermined time period is elapsed since the third information is acquired; and
a service executing part configured to execute a service by using the third information,
wherein an area capable of acquiring the third information by the third information acquisition part is broader than an area capable of acquiring the first information by the first information acquisition part.

2. The wireless device of claim 1, further comprising a data holding part configured to hold data,
wherein the service execution part acquires data held in the data holding part by using the third information to execute the service using the data.

3. The wireless device of claim 1, wherein the second information generator invalidates the second information generated after passing through the first gate, when passing through a second gate.

4. The wireless device of claim 1, wherein the second information generator invalidates the second information after a predetermined time period is elapsed since the first information is acquired.

5. The wireless device of claim 1, wherein the first information is entry information indicating that the wireless device passes through the first gate, and the second information is key information which acquires the third information.

6. The wireless device of claim 5, wherein the second information is an authentication key, and the third information acquisition part performs authentication with an information providing apparatus by using the authentication key and acquires the third information by wireless communication from the information providing apparatus when the authentication is successful.

7. The wireless device of claim 5, wherein the second information is a decryption key which decrypts the encrypted data, and the third information acquisition part decrypts the encrypted third information by the decryption key.

8. The wireless device of claim 1, further comprising an unique information holding part which holds its own unique information,
wherein the second information generator generates the second information by using the first information and the unique information.

9. The wireless device of claim 8, further comprising an unique information transmitter configured to transmit the unique information held by the unique information holding part to an information providing apparatus which transmits the third information when passing through the first gate.

10. An information providing apparatus, comprising:
a first information providing part which provides first information to a wireless device passing through a first gate;
a second information generator configured to generate second information using the first information;
a third information providing part configured to provide third information by a wireless communication using the second information and stop providing the third information after a predetermined time period is elapsed since the first information is provided.

11. The information providing apparatus of claim 10, wherein the second information generator invalidates the second information generating after the wireless device passes through the first gate, after the wireless device passes through a second gate.

12. The information providing apparatus of claim 10, wherein the second information generator invalidates the second information after a predetermined time period is elapsed since the wireless device passing through the first gate is provided with the first information.

13. The information providing apparatus of claim 10, wherein the first information is entry information indicating that the wireless device passes through the first gate, and the second information is key information which provides the third information.

14. The information providing apparatus of claim 13, wherein the second information is an authentication key, and the third information providing part performs authentication with the wireless device by using the authentication key and provides the third information by wireless communication when the authentication is successful.

15. The information providing apparatus of claim 13, wherein the second information is an encryption key which encrypts the third information, and the third information providing part encrypts the third information by the encryption key.

16. The information providing apparatus of claim 10, further comprising an unique information acquisition part which acquires unique information of the wireless device,
wherein the second information generator generates the second information by using the first information and the unique information.

17. A wireless communication method, comprising:
acquiring first information by using a wireless device when the wireless device passes through a first gate;
generating second information by the wireless device and an information providing apparatus by using the first information;
acquiring third information from the information providing apparatus by wireless communication by using the second information and invalidating the third information after a predetermined time period is elapsed since the third information is acquired,
wherein the wireless device executes a service by using the third information; and
an area capable of acquiring the third information is broader than an area capable of acquiring the first information.

18. The method of claim 17, further comprising holding data,
wherein when the wireless device executes the service, the held data is acquired by using the third information to execute the service using the data.

19. The method of claim 17, wherein the second information generated after passing through the first gate is invalidated when passing through the second gate.

20. The method of claim 17, wherein the second information is invalidated after a predetermined time period is elapsed since the first information is acquired.
